(19) United States
(12) Patent Application Publication
(10) Pub. No.: US 2016/0042147 A1
(43) Pub. Date: Feb. 11, 2016

(54) PRESCRIPTION PRODUCT INVENTORY REPLENISHMENT

(71) Applicant: MCKESSON CORPORATION, San Francisco, CA (US)

(72) Inventors: Andrew Maurer, Atlanta, GA (US); Richard K. Selby, Duluth, GA (US); Amanda R. Gaddy, McDonough, GA (US); Chuck Nelson, San Francisco, CA (US); Sam Thompson, Santa Rosa Beach, FL (US); Jon Cox, Newcastle, OK (US)

(21) Appl. No.: 14/453,397

(22) Filed: Aug. 6, 2014

(51) Int. Cl. G06F 19/00; G06Q 50/24

(52) U.S. Cl. CPC G06F 19/3456; G06Q 50/24

(57) ABSTRACT

Systems, methods, and computer-readable media are disclosed for determining whether a portion of an auto-generated prescription product order is eligible for replenishment at a reduced price, such as a 340B price, and if so determined, partitioning the order to replenish the portion of the order at the reduced price. The number of 340B accumulations accrued by a contract pharmacy on behalf of a covered entity may be determined, and a prescription product order may be partitioned into an order for those items that can be replenished at the 340B price based on the number of 340B accumulations and an order for the remaining items purchased at a higher price such as a WAC price.

### TECHNICAL FIELD

This disclosure relates generally to the replenishment of prescription product inventory, and more particularly, to determining whether a portion of an auto-generated prescription product order is eligible for replenishment at a reduced price, and if so, partitioning the order to enable replenishment of the portion of the order at the reduced price.

### BACKGROUND

Various government-sponsored and non-government-sponsored programs and entities exist for providing reduced costs for prescription products such as prescription medications, medical devices, and other prescription products. Such programs or entities may include, for example, the federal 340B drug pricing program, healthcare group purchasing organizations (GPOs), patient assistance programs (PAPs) available through pharmaceutical companies or governmental organizations such as Medicare or Medicaid, and so forth.

In 1992, Section 340B of the Public Health Service Act was enacted under Section 602 of the Veterans Healthcare Act of 1992. Section 340B requires drug manufacturers to provide outpatient drugs to eligible healthcare centers, clinics, and hospitals (referred to as “covered entities”) at a reduced price. This reduced price (sometimes interchangeably referred to as the “340B price,” the “Public Health Service (PHS) price,” the “602 price,” or the like) represents a maximum price that a covered entity would have to pay for select prescription drugs dispensed in accordance with the requirements of Section 340B and is often significantly lower than the Wholesale Acquisition Cost (WAC) price for such drugs.

A “covered drug” under the 340B program may include, for example, a Federal Drug Administration (FDA) approved prescription drug, an over-the-counter (OTC) drug that is written on a prescription, and so forth. Covered entities eligible to participate in the 340B program generally include entities that serve indigent or historically disenfranchised populations or that focus on treating particular disease conditions such as, for example, federally-qualified health centers, hospitals that treat indigent patients through a disproportionate share hospital (DSH) program, children's hospitals, free standing cancer clinics, family planning projects, state-operated AIDS Drug Assistance Programs (ADAPs), black lung clinics receiving federal funds, and so forth. Prescription drug purchases at the 340B price represent a significant cost savings over the typical costs for such drugs. The cost savings can, in turn, be passed on to patients, thereby reducing the overall cost of patient care to both healthcare providers and patients.

The 340B program allows covered entities to contract with retail pharmacies to dispense, on their behalf, covered drugs purchased under the 340B program. Contract pharmacy arrangements help to facilitate 340B program participation for those covered entities that do not have access to in-house pharmacy services, for those covered entities that wish to supplement in-house pharmacy services, and for those covered entities that wish to utilize multiple contract pharmacies to increase patient access to 340B covered drugs.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic depiction of an illustrative system architecture for replenishing prescription product inventory in accordance with one or more example embodiments of the disclosure.

FIG. 2 depicts hardware and software components of an illustrative computing device in accordance with one or more example embodiments of the disclosure.

FIGS. 3A-3B are process flow diagrams of an illustrative method for determining whether a portion of an auto-generated prescription product order is eligible for replenishment at a reduced price in accordance with one or more example embodiments of the disclosure.

FIG. 4 is a process flow diagram of an illustrative method 400 for invoicing contract pharmacies for revenues obtained by the contract pharmacies for 340B qualifying dispenses that have been replenished and which were made on behalf a covered entity in accordance with one or more example embodiments of the disclosure.

### DETAILED DESCRIPTION

### Overview

Example embodiments of the disclosure relate generally to systems, methods, computer-readable or machine-readable media, techniques, and methodologies for determining whether a portion of an auto-generated prescription product order is eligible for replenishment at a reduced price, such as a 340B price, and if so, partitioning the order into a first order of a quantity of the prescription product eligible for replenishment at the reduced price and a second order of a quantity of the prescription product eligible at a standard price such as a Wholesale Acquisition Cost (WAC) price. While example embodiments of the disclosure may be described in connection with prescription drugs eligible for reduced pricing under a sponsored program (e.g., the federal 340B drug pricing program), it should be appreciated that embodiments of the disclosure may be applicable to any prescription product eligible for reduced pricing under any suitable pricing program. In addition, the term “prescription product” or “prescription drug” may refer to any product or drug dispensed in connection with a prescription issued by a healthcare provider such as, for example, an FDA approved prescription drug, an OTC drug written on a prescription, or the like.

Various government or non-government sponsored programs exist for providing covered entities with prescription drugs at reduced prices. One such program is the federal 340B drug pricing program. The 340B price for a prescription drug is often significantly lower than the WAC price for the drug that non-covered entities, such as retail pharmacies, typically pay.

In order to be eligible to purchase a prescription drug at the 340B price, however, a covered entity must meet certain requirements. One such requirement may be that the prescription drug qualify for 340B pricing. Another requirement for eligibility to purchase a drug at the 340B price may be that the drug is dispensed to an outpatient. For example, a covered entity such as a DSH hospital, children's hospital, or the like may be required to dispense the prescription drug to an outpatient in order to qualify for 340B pricing for the drug.

Pursuant to the 340B program, a covered entity may enter into a contractual relationship with a non-covered entity (e.g., a retail pharmacy) that allows the non-covered entity (the retail pharmacy) to dispense 340B drugs on behalf of the covered entity. Retail pharmacies that contract with covered entities to dispense 340B drugs on behalf of the covered entities may be referred to herein, at times, as “contract pharmacies.” Drug replenishments at the 340B price may be billed to the covered entity, and the contract pharmacy may charge a dispensing fee for its services on behalf of the covered entity. Although the pharmacy may charge the covered entity a dispensing fee, the arrangement may nonetheless be advantageous for the covered entity because the sum of the dispensing fee and the 340B price for the drug may still be less (potentially significantly less) than the WAC price.

Contractual arrangements between covered entities and contract pharmacies typically utilize a “ship to, bill to” procedure according to which the covered entity purchases the covered drug, and the manufacturer or wholesaler that provides the drug bills the covered entity for the purchase but ships the drug directly to the contract pharmacy for dispensing by the pharmacy. The covered entity is responsible for compliance of their contract pharmacy arrangements with the requirements of the 340B program and must maintain ownership of the 340B drugs dispensed by the contract pharmacies. For example, the covered entity is responsible for ensuring that covered drugs obtained at a 340B price are not diverted to individuals that are not patients of the covered entity and that a dispensed drug is not subject to both the 340B discount and a Medicaid rebate claim.

A 340B drug may be replenished at the reduced 340B price in fixed incremental amounts. For example, in the case of a prescription drug that is dispensed in a discrete form (e.g., a pill, capsule, tablet, etc.), the minimum incremental purchasable amount may be a fixed number of dispensable units of the drug (e.g., a bottle containing 100 pills). As another example, in the case of a prescription drug that is dispensed as a fluid or semi-fluid (e.g., a liquid or gel), the minimum incremental purchasable amount may be a fixed volume or weight of the drug. In addition, although a contract pharmacy may dispense a 340B drug on behalf of a covered entity, a separate 340B account maintained on behalf of the covered entity is typically used for billing the covered entity for replenishment of 340B eligible dispenses of the drug as compared to non-340B eligible dispenses of the drug or non-340B eligible drugs dispensed by the pharmacy.

Because, as noted above, 340B eligible dispenses of a drug are typically replenished in fixed incremental amounts and because a contract pharmacy's replenishment of 340B eligible dispenses of a drug are billed to a covered entity account that is separate and distinct from the pharmacy account to which replenishments for non-340B dispenses are billed, a phenomenon known as “inventory swell” may occur. For example, pharmacies typically utilize a prescription fulfillment system that monitors existing inventory and automatically generates prescription fulfillment orders to replenish the inventory. Such systems may be referred to as “perpetual inventory systems.” If a pharmacy, however, is also a contract pharmacy, prescription drug dispenses to 340B eligible patients that reach a replenishment threshold (e.g., a minimum incremental amount eligible for purchase at the 340B price) may be replenished separately from an auto-generated prescription drug order. This may occur because prescription drug orders purchased at the 340B price may be billed to a separate account maintained on behalf of the covered entity, whereas auto-generated prescription drug orders may be billed to a retail account maintained on behalf of the contract pharmacy. As a result, pharmacies may end up with more inventory than they need or desire.

In an example scenario of inventory swell, a contract pharmacy's perpetual inventory system may auto-generate an order for 10 bottles of a certain prescription drug based on an assessment of currently available inventory. In addition, the contract pharmacy may have accumulated enough 340B qualifying dispenses to replenish 2 bottles of the prescription drug at the 340B price (e.g., at least 200 dispenses for a drug that is sold as 100-count bottles). Thus, the pharmacy may receive 10 bottles based on the auto-generated order and may also receive 2 additional bottles replenished at the 340B price. As such, the pharmacy may receive an excess amount of the drug than what the contract pharmacy needs to replenish its inventory.

Example embodiments of the disclosure provide a number of technical effects including, without limitation, elimination of a contract pharmacy's exposure to inventory swell. In example embodiments of the disclosure, a service provider system may be provided that receives prescription drug orders from prescription fulfillment systems supporting various retail pharmacy locations. While example embodiments of the disclosure may be described in connection with a particular pharmacy chain that includes multiple pharmacy locations, it should be appreciated that embodiments of the disclosure are applicable to any number of pharmacies including any number of pharmacy locations of the pharmacies, as well as, any type of pharmacy organizational structure.

In an example embodiment of the disclosure, the service provider system may receive prescription drug orders from multiple retail pharmacy locations of a particular retail pharmacy chain. More specifically, the service provider system may receive the prescription drug orders from perpetual inventory systems provided at or otherwise associated with the various retail pharmacy locations.

Upon receipt of the prescription drug orders, the service provider system may identify a subset of the orders that were received from contract pharmacies, that is, retail pharmacy locations that have contracted with a covered entity to dispense 340B drugs on behalf of the covered entity. For example, if 4000 orders are received from retail pharmacy locations on a particular day, 1600 of those orders may be identified as having been received from contract pharmacy locations. Those orders not received from contract pharmacy locations may be fulfilled and billed to a retail account maintained on behalf of the pharmacy chain or to individual retail accounts maintained on behalf of the various retail pharmacy locations. On the other hand, those orders received from contract pharmacies may be further processed to determine the number of ordered prescription drug items (if any) that are eligible for replenishment at a 340B price. An “item” of a prescription drug may refer to a stock keeping unit (SKU) of the drug which may, in turn, refer to a distinct physical item offered for sale. For example, a SKU of a prescription drug may be a bottle containing a predetermined number of pills, capsules, or other dispensable form of the drug; a container containing a predetermined volume or weight of the drug; or the like.

In particular, to determine 340B eligible dispenses made by the contract pharmacy locations, the service provider system may compare dispensing data received from pharmacy computers to patient encounter data received from the covered entity. The pharmacy computers may be provided locally at the pharmacy locations or may support the operations of the pharmacy locations remotely. For example, the dispensing data may include a respective data record corresponding to each discrete dispensing of the prescription drug. The service provider system may locate one or more data fields in each such data record and compare the data populated therein to the patient encounter data received from the covered entity to determine whether the corresponding dispensing was to a 340B eligible patient. The data that is compared may include a patient identifier, an identifier that indicates whether the patient is an outpatient, and so forth. Each 340B eligible dispensed unit of a drug may be referred to herein as a “340B accumulation.” For example, for a drug dispensed in pill form, each pill dispensed to a 340B eligible patient may correspond to a 340B accumulation.

The service provider system may also receive data from third-party service providers that indicates 340B eligible dispenses made by contract pharmacy locations that have contracted with one or more other covered entities to dispense 340B drugs on their behalf. More specifically, in certain example embodiments, certain other covered entities may enter into arrangements with third-party service providers other than a service provider with which the service provider system is associated. In such scenarios, the service provider system may not receive patient encounter data from these other covered entities, and thus, may not be able to determine the number of 340B eligible dispenses made by contract pharmacies that have contracted with these other covered entities. Accordingly, the service provider system may receive data from one or more third-party service providers that indicates the number of 340B eligible dispenses made by contract pharmacies on behalf of these over covered entities.

Upon determining the number of 340B accumulations for a drug prescribed by a covered entity based on an analysis of dispensing data received from contract pharmacies to patient encounter data received from a covered entity (or based on data received from third-party service providers that indicates 340B eligible dispenses made on behalf of a covered entity), the service provider system may determine the number of ordered prescription drug items eligible for replenishment at the 340B price. As previously discussed, in certain example embodiments, a prescription drug may only be purchasable at the 340B price once a threshold number of 340B accumulations have accrued corresponding to a minimum incremental purchasable amount of the drug. For example, for a prescription drug dispensed in pill form, the minimum incremental purchasable amount may be a bottle that includes 100 pills. In such a scenario, 100 340B accumulations of the drug may need to occur before a bottle can be purchased at the 340B price. It should be noted that the 100 340B accumulations may correspond to dispenses to any number of patients.

Those ordered prescription drug items eligible for replenishment at the 340B price may then be allocated to a 340B account maintained on behalf of the covered entity. The remaining balance of ordered prescription drug items may be allocated to a retail account held by the pharmacy chain or one or more retail accounts of the various contract pharmacy locations. Referring to the same example introduced above, if a particular contract pharmacy location has ordered 10 bottles of the prescription drug and has accrued 450 340B accumulations, 4 bottles of the prescription drug may be purchased at the 340B price and charged to the covered entity's 340B account, and the remaining 6 bottles may be purchased at the WAC price and charged to the retail account for the contract pharmacy location. Thus, in certain example embodiments, the prescription drug order for 10 bottles received from the contract pharmacy location may be partitioned into two orders—one for 4 bottles at the 340B price and another for 6 bottles at the WAC price. It should be appreciated that, in certain example embodiments, a contract pharmacy may not have made enough 340B qualifying dispenses to accrue the threshold number of 340B accumulations needed to meet the minimum incremental purchasable amount of the drug. In such scenarios, the entire prescription drug order for the contract pharmacy may be purchased at the WAC price and billed to the retail pharmacy account. It should further be appreciated that, in various other example embodiments, the 340B accumulations may be consolidated across multiple contract pharmacy locations in order to determine the number of incremental units eligible for replenishment at the 340B price. For example, a total number of 340B accumulations for multiple contract pharmacies may be determined, and the total number of prescription drug items ordered by the multiple contract pharmacies may be partitioned among those items eligible for replenishment at the 340B price and those to be replenished at the WAC price.

Upon determining the number of ordered prescription drug items eligible for replenishment at the 340B price, the service provider system may place a hold on the corresponding 340B accumulations until confirmation is received that the order can be fulfilled. Upon receipt of confirmation, which may be in the form of, for example, an invoice, the 340B accumulations corresponding to the number of items replenished at the 340B price may be decremented. Continuing with the example introduced above, assuming 450 340B accumulations for a contract pharmacy location and fulfillment of 4 100-count bottles at the 340B price, the 340B accumulations may be decremented to 50 340B accumulations. In addition, prior to transmitting the invoice to the contract pharmacy location, the service provider system may replace any 340B pricing indicated on the invoice with WAC pricing instead. Continuing with the example introduced above, the WAC price may instead be indicated for the 4 bottles purchased at the 340B price.

In addition, the service provider system may provide any third-party service provider from whom 340B eligible dispensing data was received with various reports such as, for example, a report identifying the number of 340B accumulations eligible for replenishment at the 340B price. The third-party service provider may utilize this information to decrement a counter that it maintains for the number of 340B accumulations for a covered entity. In addition, the service provider system may provide a third-party service provider with a purchase report indicating purchase information for orders fulfilled for contract pharmacies dispensing 340B drugs on behalf a covered entity serviced by the third-party service provider. The purchase information may include, for example, a National Drug Code (NDC) identifier for the drug, the number of units purchased at the 340B price, the number of units purchased at the WAC price, an invoice identifier, and so forth.

As previously noted, prescription drugs dispensed by a contract pharmacy to 340B eligible patients on behalf of a covered entity may be replenished on the covered entity's account instead of the contract pharmacy's retail account. More specifically, in accordance with the “ship to, bill to” protocol described above, prescription drugs purchased at the 340B price may be billed to the covered entity but shipped to the contract pharmacy. As such, revenues that the contract pharmacy receives from dispensing drugs to 340B eligible patients—either from the patient or from reimbursements received from insurance payors or the like—are distributed to the covered entity.

In accordance with example embodiments of the disclosure, the service provider system may analyze dispensing data received from a contract pharmacy with patient encounter data received from a covered entity to determine the number of 340B qualifying dispenses made by the contract pharmacy. The service provider system may further access stored information to determine dispensing fees charged by the contract pharmacy as well as the number of prescription drug units that have been replenished at the 340B price. The service provider system may then determine an invoice amount for the contract pharmacy based on the number of 340B qualifying dispenses, the dispensing fees, and the number of prescription drug units that have been replenished. In certain example embodiments, the contract pharmacy may not be invoiced for 340B qualifying dispenses until the drug has been replenished at the 340B price. For example, if 30 tablets dispensed from a 100-count bottle are determined to be 340B eligible, the contract pharmacy may not be invoiced for the corresponding revenues (less dispensing fees) until an additional 70 tablets are dispensed to 340B eligible patients and the 100-count bottle is replenished at the 340B price.

Upon determining an invoice amount for a contract pharmacy, the service provider system may transmit the invoice to the contract pharmacy. Funds received from the contract pharmacy as payment for the invoice may be stored in a funds repository until transferred to a financial account associated with the covered entity. In addition, any funds received from contract pharmacies that dispense 340B drugs on behalf of covered entities not serviced by a service provider that operates or controls the service provider system may be transferred to financial accounts held by third-party service providers for eventual distribution to the appropriate covered entities.

Example embodiments disclosed herein provide a number of technical effects or advantages including, without limitation, elimination of the inventory swell phenomenon described above by integrating the processes for fulfillment of auto-generated prescription drug orders with processes for replenishing drugs at the 340B price, elimination of “slow moving drug/partial package” reconciliation by using billing and invoicing protocols that ensure that a contract pharmacy is not invoiced for 340B qualifying dispenses until replenishment occurs, creation of mechanisms for reporting 340B accumulation data and purchasing data to third-party service providers to enable accurate record-keeping on the part of the third-party service providers, and so forth.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. In addition, it should be appreciated that the example technical effects described above are merely illustrative and not exhaustive. The above-described embodiments and additional and/or alternative embodiments of the disclosure will be described in detail hereinafter through reference to the accompanying drawings.

### Illustrative System Architecture

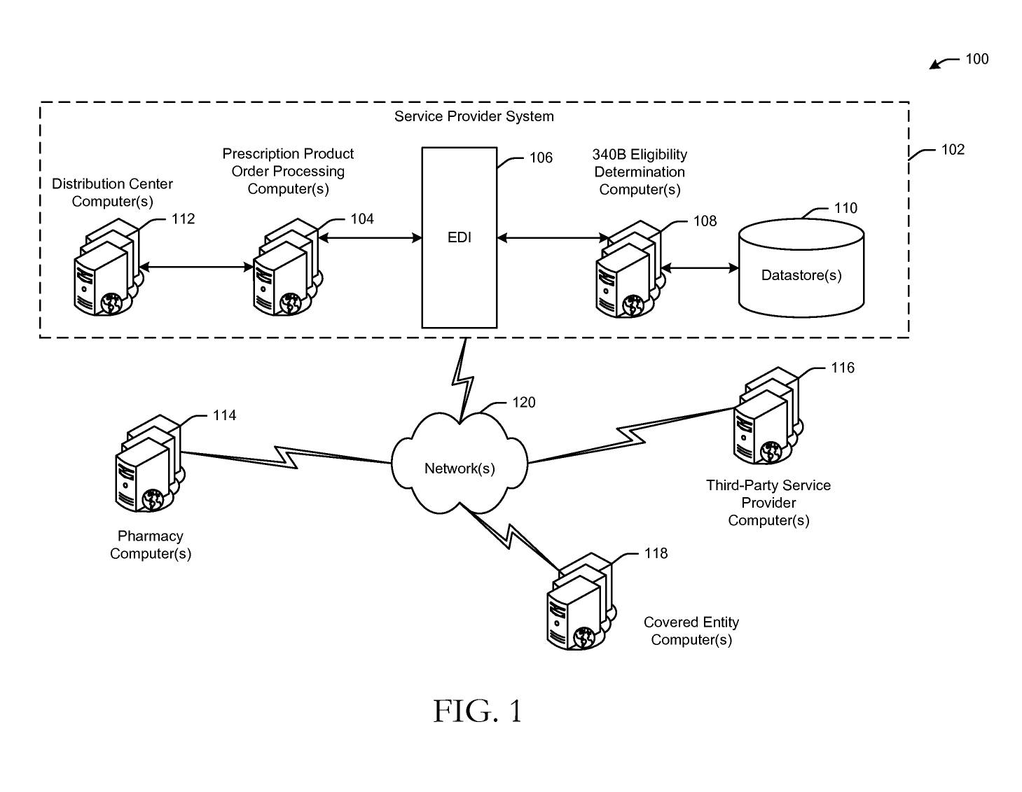

FIG. 1 is a schematic depiction of an illustrative system architecture 100 for replenishing prescription product inventory in accordance with one or more example embodiments of the disclosure.

The system architecture 100 may include a service provider system 102 that, in turn, may include one or more prescription product order processing computers 104, an electronic data interchange (EDI) 106, one or more 340B eligibility determination computers 108, and one or more distribution center computers 112. The service provider system 102 may further include one or more datastores 110. The system architecture 100 may additionally include one or more pharmacy computers 114 that may be associated with any number of pharmacy locations, one or more third-party service provider computers 116 that may be associated with any number of third-party service providers, and one or more covered entity computers 118 that may be associated with any number of covered entities. While any of the illustrative components of the system architecture 100 (including any of the example components of the service provider system 102) may at times be referred to herein in the singular, it should be appreciated that multiple ones of any of the components may be provided. In addition, one or more components of the service provider system 102 depicted in FIG. 1 may not form part of the system 102 in certain example embodiments, while, in other example embodiments, additional components may be provided as part of the service provider system 102.

Any of the illustrative components of the architecture 100 may be configured to communicate with one or more other components of the architecture 100 via one or more networks 120. The network(s) 120 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 120 may have any suitable communication range associated therewith and may include, for example, global networks (e.g., the Internet), metropolitan area networks (MANs), wide area networks (WANs), local area networks (LANs), or personal area networks (PANs). In addition, the network(s) 120 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

The network(s) 120 may allow for real-time, off-line, and/or batch transactions to be transmitted between any of the illustrative components of the architecture 100. In one or more example embodiments, the illustrative system architecture 100 may be implemented in the context of a distributed computing environment. Further, it should be appreciated that the illustrative system architecture 100 may be implemented in accordance with any suitable network configuration. For example, the network(s) 120 may include a plurality of networks, each with devices such as gateways, routers, linked-layer switches, and so forth for providing connectivity between or among the various devices forming part of the system architecture 100. In some example embodiments, dedicated communication links may be used to connect the various devices of the architecture 100.

One or more of the prescription product order processing computer 104, the EDI 106, the 340B eligibility determination computer 108, the distribution center computer 112, the pharmacy computer 114, the third-party service provider computer 116, or the covered entity computer 118 may include one or more processing units that may be configured to access and read computer-readable media having stored thereon data and/or computer-executable instructions for implementing various functionality described herein. Any of the illustrative components of the architecture 100 may include or otherwise be associated with suitable hardware, firmware, and/or software components for receiving, processing, and/or transmitting data and/or computer-executable instructions over one or more communications links or networks. These networked devices and systems may also include any number of processors for processing data and executing computer-executable instructions, as well as other internal and peripheral components. Further, these networked devices and systems may include or be in communication with any number of suitable memory devices operable to store data and/or computer-executable instructions. By storing and/or executing computer-executable instructions, each of the networked devices may form a special purpose computer or a particular machine.

Referring now more specifically to example types of functionality that various components of the architecture 100 may support, the pharmacy computer 114 may be configured with hardware, firmware, and/or software to monitor pharmacy prescription product inventory levels and generate prescription product orders. In particular, the pharmacy computer 114 may be configured to auto-generate prescription product orders by monitoring prescription product inventory levels and triggering the generation and routing of prescription product orders to the service provider system 102 in response to determining that inventory levels drop below predetermined thresholds.

The prescription product order processing computer 104 may be configured to receive prescription product orders, such as auto-generated prescription product orders, from any number of pharmacy computers 114 associated with any number of pharmacy locations. Upon receipt of such prescription product orders, the prescription product order processing computer 104 may execute processing to identify those orders received from contract pharmacies that have contracted to dispense 340B drugs on behalf of covered entities serviced by a service provider associated with the service provider system 102. The prescription product order processing computer 104 may be configured with any suitable hardware, firmware, and/or software for executing such processing. In particular, the prescription product order processing computer 104 may locate a pharmacy location identifier (e.g., a store identifier) included in a prescription product order and query a datastore (e.g., one or more of the datastore(s) 110) to determine whether the pharmacy location identifier matches an identifier in a stored table, listing, or the like of contract pharmacy identifiers. If a match is detected, the prescription product order may be identified as having been received from a contract pharmacy.

Upon identifying a subset of prescription product orders received from contract pharmacies, the prescription product order processing computer 104 may transmit the subset of orders (e.g., information included in the subset of orders) to the 340B eligibility determination computer 108 via the EDI 106. The EDI 106 may include an electronic communication system that permits the electronic exchange of structured data in accordance with one or more standardized protocols. For example, the EDI 106 may convert data included in the subset of prescription product orders to structured data represented in a standardized message format that can be interpreted by the 340B eligibility determination computer 108.

Upon receipt of one or more EDI messages that include data contained in the subset of prescription product orders, the 340B eligibility determination computer 108 may store the order data in one or more of the datastore(s) 110. In addition, the 340B eligibility determination computer 108 may receive a data feed from one or more pharmacy computers 114 that includes dispensing data for at least the contract pharmacies that submitted prescription product orders included in the subset of orders. The 340B eligibility determination computer 108 may further receive patient encounter data from a covered entity via one or more covered entity computers 118.

The dispensing data received from the pharmacy computer(s) 114 may include multiple data records with each data record corresponding to a particular dispensing of a drug. Each data record may indicate, for example, an NDC code for the drug, the number of dispensed units of the drug, a prescription identifier, a patient identifier indicating the patient to whom the drug was dispensed, a code, flag, or other identifier indicating whether the patient was an inpatient or an outpatient, and so forth. The patient encounter data may include a respective data record corresponding to each patient encounter with the covered entity. An example data record included in the patient encounter data may include a patient identifier, a covered entity identifier, a prescription identifier, an NDC code, and so forth. The dispensing data and patient encounter data may be stored in one or more of the datastore(s) 110.

The 340B eligibility determination computer 108 may execute one or more scripts or the like to perform one or more comparisons of the dispensing data to the patient encounter data to determine those dispenses that were made on behalf of the covered entity to 340B eligible patients. As a non-limiting example, if a data record included in the patient encounter data includes a patient identifier and a prescription identifier that matches corresponding identifiers included in a data record of the dispensing data, the corresponding dispensing may be determined to be a 340B qualifying dispensing. The number of units of the drug dispensed as part of the 340B qualifying dispensing may be determined and a counter representative of 340B accumulations for the contract pharmacy may be correspondingly increased.

The 340B eligibility determination computer 108 may also receive a data feed from one or more third-party service provider computers 116 that includes dispensing data for 340B qualifying dispenses made by the contract pharmacy on behalf of one or more other covered entities serviced by one or more third-party service providers. The 340B eligibility determination computer 108 may not need to perform any testing of the dispensing data received from the third-party service provider computer(s) 116 since the data may directly indicate 340B qualifying dispenses. Dispensing data received from third-party service provider computer(s) 116 may be stored in one or more of the datastore(s) 110.

Based on testing of dispensing data received from pharmacy computer(s) 114 in relation to patient encounter data, as well as, receipt of any 340B qualifying dispensing data from third-party service provider computer(s) 116, the 340B eligibility determination computer 108 may determine the number of 340B accumulations accrued by a contract pharmacy on behalf of a covered entity over time. As previously noted, it should be appreciated that the number of 340B accumulations may be evaluated on a per-contract pharmacy basis or may be consolidated across all contract pharmacies (or some subset thereof) that have contracted to dispense drugs to 340B eligible patients on behalf of a covered entity. In certain example embodiments, a respective counter may be maintained for each contract pharmacy that indicates the number of 340B accumulations that the contract pharmacy has accrued. In other example embodiments, a counter may be maintained that indicates 340B accumulations across multiple contract pharmacies for a covered entity. Further, in certain example embodiments, each counter that is maintained by correspond to a particular covered entity and any counters that are maintained may be stored in one or more of the datastore(s) 110.

The 340B eligibility determination computer 108 may then determine the number of ordered prescription drug items that can be replenished at the 340B price from the number of 340B accumulations, and may partition the prescription drug orders accordingly. For example, if a contract pharmacy has ordered 10 units of a prescription drug, where each unit is a 100-count bottle, and has accrued 220 340B accumulations, the 340B eligibility determination computer 108 may determine that 2 bottles of the drug may be purchased at the 340B price and that the remaining 8 bottles must be purchased at the WAC price. Thus, in certain example embodiments, the 340B eligibility determination computer 108 may partition the prescription drug order for 10 bottles into two orders—one for 2 bottles at the 340B price and another for 8 bottles at the WAC price. The 2 bottles purchased at the 340B price may be billed to a 340B account associated with the covered entity and the 8 bottles purchased at the WAC price may be billed to a retail account associated with the contract pharmacy. It should be appreciated that, in certain example embodiments, a contract pharmacy may not have made enough 340B qualifying dispenses to accrue the threshold number of 340B accumulations needed to meet the minimum incremental purchasable amount for the drug. In such scenarios, the entire prescription drug order for the contract pharmacy may be purchased at the WAC price and billed to the retail pharmacy account. It should further be appreciated that, in various other example embodiments, the 340B accumulations may be consolidated across multiple contract pharmacy locations in order to determine the number of incremental units eligible for replenishment at the 340B price.

The 340B eligibility determination computer 108 may store data indicating prescription drug items ordered on a covered entity's 340B account and items ordered on a pharmacy's retail account in one or more of the datastore(s) 110. Further, upon determining the appropriate allocation of ordered prescription drug items between a covered entity's 340B account and a contract pharmacy's retail account, the 340B eligibility determination computer 108 may transmit the partitioned orders to the prescription product order processing computer 104 via the EDI 106. The prescription product order processing computer 104 may then perform any additional processing on the orders that is required and transmit to the orders to the distribution center computer 112 for fulfillment.

As previously described, the 340B eligibility determination computer 108 may place a hold on 340B accumulations eligible for replenishment at the 340B price until confirmation is received that the order can be fulfilled. Upon receipt of confirmation, which may be in the form of, for example, an invoice, a counter representing the 340B accumulations may be decremented by the number of 340B accumulations that resulted in replenishment of the drug at the 340B price. For example, assuming 702 340B accumulations for a contract pharmacy location and fulfillment of 7 100-count bottles at the 340B price, the 340B accumulations may be decremented to 2 340B accumulations.

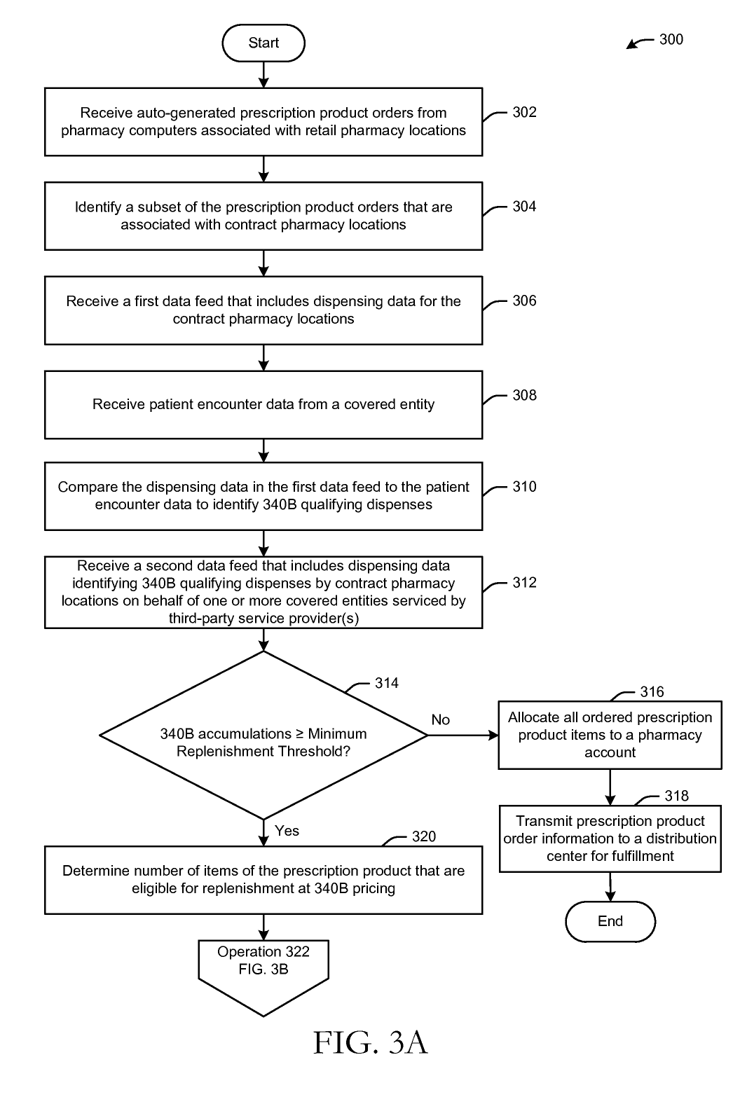

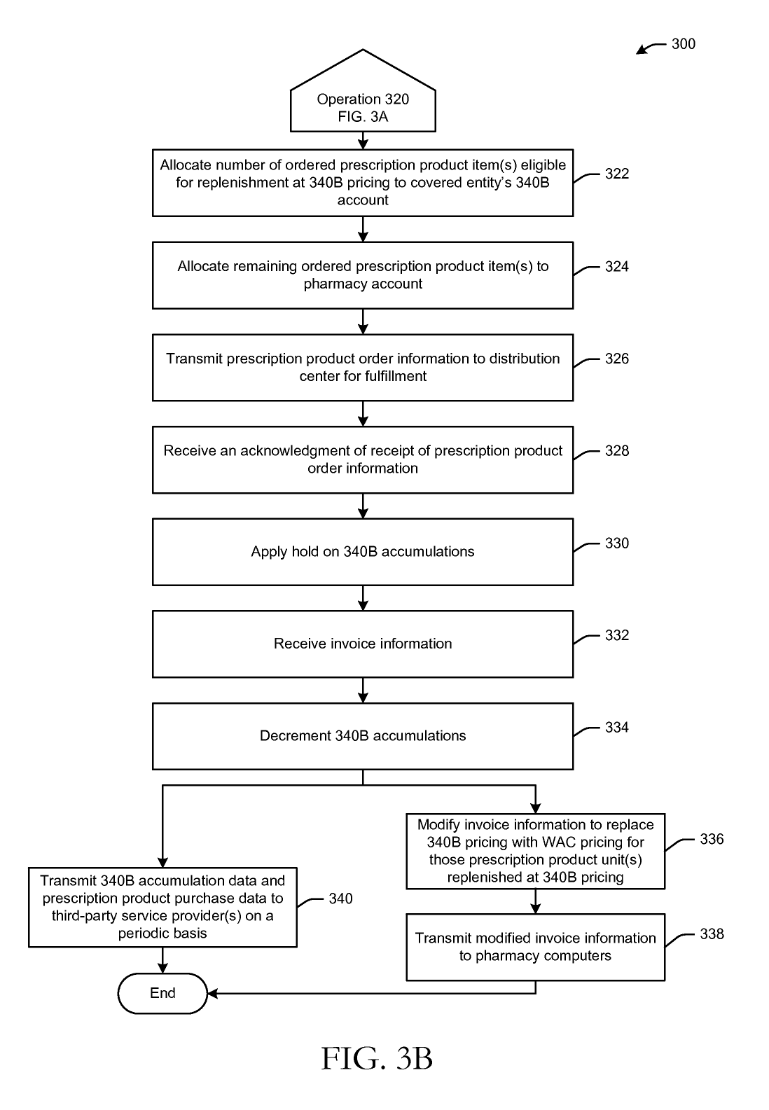

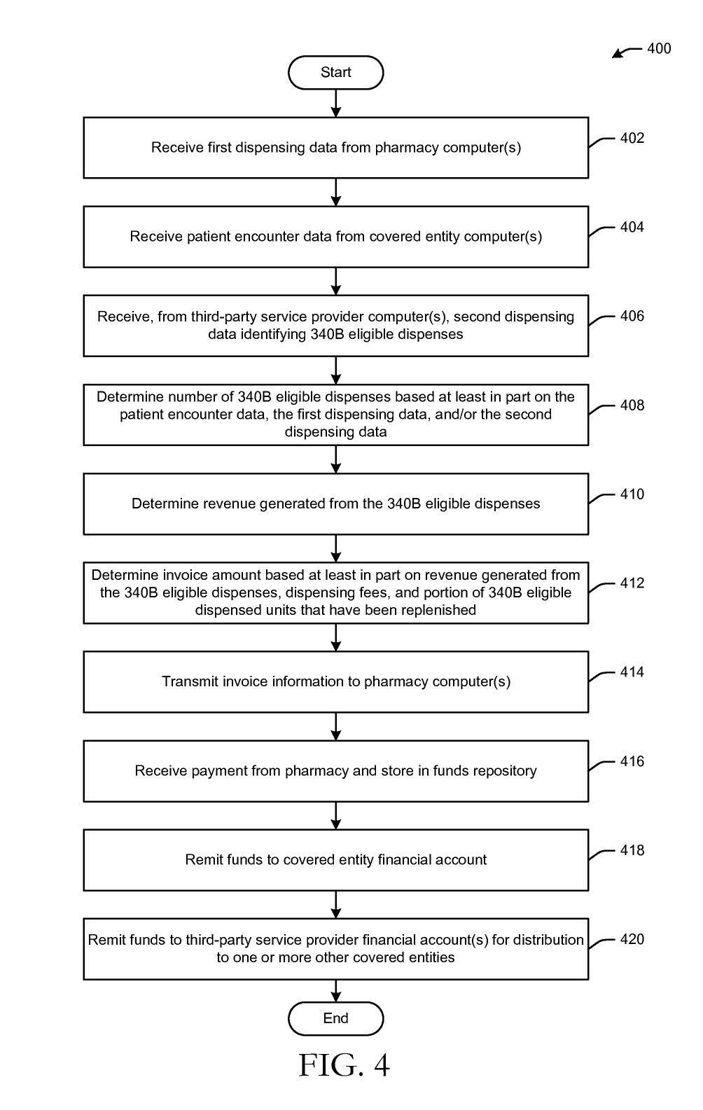

In addition, the 340B eligibility determination computer 108 may further execute processing to provide any third-party service provider from whom dispensing data was received with various reports such as, for example, 340B accumulations reports, purchase reports, and so forth, as described above. The 340B eligibility determination computer 108 may also execute processing to generate invoices for billing contract pharmacies for revenues generated from the dispensing of drugs to 340B eligible patients on behalf of covered entities. While report generation and invoicing functionality may be described herein as being supported by the 340B eligibility determination computer 108, it should be appreciated that such functionality may be provided by any one or more components of the service provider system 102. Report generation and invoicing functionality supported by the service provider system 102 will be described in greater detail with reference to the process flow diagrams depicted in FIGS. 3A-4.

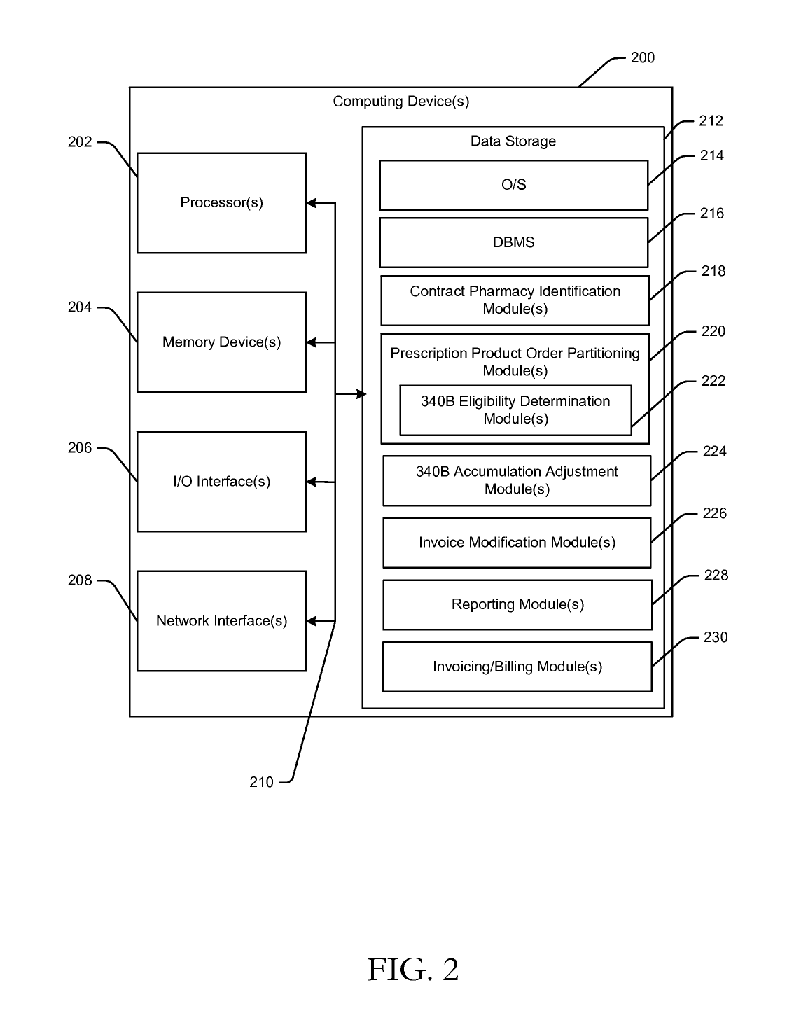

FIG. 2 depicts example hardware and software components of an illustrative computing device 200 in accordance with one or more example embodiments of the disclosure. The computing device 200 may form part of the service provider system 102. It should be appreciated that the computing device 200 may actually represent multiple computing devices that operate in accordance with a distributed computing model. Certain program modules depicted and described as part of the illustrative configuration of the computing device 200 depicted in FIG. 2 may actually reside on and may be executed on different devices of the service provider system 102. For example, one or more program modules may reside on one or more prescription product order processing computers 104, while one or more other program modules may reside on one or more 340B eligibility determination computers 108. In addition, any given program module may be partitioned across multiple devices of the service provider system 102.

In an illustrative configuration, the computing device 200 may include one or more processors (processor(s)) 202, one or more memory devices 204 (generically referred to herein as memory 204), one or more input/output (“I/O”) interface(s) 206, one or more network interfaces 208, and data storage 212. The device 200 may further include one or more buses 210 that functionally couple various components of the device 200. These various components will be described in more detail hereinafter.

The bus(es) 210 may include at least one of a system bus, a memory bus, an address bus, or a message bus, and may permit exchange of information (e.g., data (including computer-executable code), signaling, etc.) between various components of the device 200. The bus(es) 210 may include, without limitation, a memory bus or a memory controller, a peripheral bus, an accelerated graphics port, and so forth. The bus(es) 210 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 204 of the device 200 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 204 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 204 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 212 may include removable storage and/or non-removable storage including, but not limited to, magnetic storage, optical disk storage, and/or tape storage. The data storage 212 may provide non-volatile storage of computer-executable instructions and other data. The memory 204, the data storage 212, and the datastore(s) 110, removable and/or non-removable, are examples of computer-readable storage media (CRSM) as that term is used herein.

The data storage 212 may store computer-executable code, instructions, or the like that may be loadable into the memory 204 and executable by the processor(s) 202 to cause the processor(s) 202 to perform or initiate various operations. The data storage 212 may additionally store data that may be copied to memory 204 for use by the processor(s) 202 during the execution of the computer-executable instructions. Moreover, output data generated as a result of execution of the computer-executable instructions by the processor(s) 202 may be stored initially in memory 204, and may ultimately be copied to data storage 212 for non-volatile storage.

More specifically, the data storage 212 may store one or more operating systems (O/S) 214; one or more database management systems (DBMS) 216; and one or more program modules, applications, or the like such as, for example, one or more contract pharmacy identification modules 218, one or more prescription product order partitioning modules 220, one or more 340B accumulation adjustment modules 224, one or more invoice modification modules 226, one or more reporting modules 228, and one or more invoicing/billing modules 230. Any of the program modules may include one or more sub-modules. For example, the prescription product ordering module(s) 220 may include one or more 340B eligibility determination modules 222. Any of the modules depicted in FIG. 2 may include computer-executable code, instructions, or the like that may be loaded into the memory 204 for execution by one or more of the processor(s) 202. Further, any data (e.g., data stored in one or more of the datastore(s) 110) may be loaded into the memory 204 for use by the processor(s) 202 in executing computer-executable code. As previously noted, any of the aforementioned program modules may reside on different devices of the service provider system 102.

The processor(s) 202 may be configured to access the memory 204 and execute computer-executable instructions loaded therein. For example, the processor(s) 202 may be configured to execute computer-executable instructions of the various program modules of the device 200 to cause or facilitate various operations to be performed in accordance with one or more embodiments of the disclosure. The processor(s) 202 may include any suitable processing unit capable of accepting data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 202 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 202 may be capable of supporting any of a variety of instruction sets.

Referring now to functionality supported by the various program modules depicted in FIG. 2, the contract pharmacy identification module(s) 218 may include computer-executable instructions, code, or the like that, responsive to execution by one or more of the processor(s) 202, may cause processing to be performed to identify, from among prescription drug orders received from various pharmacies, those orders received from contract pharmacies that have contracted to dispense 340B drugs on behalf of covered entities serviced by a service provider associated with the service provider system 102. The processing may include locating a pharmacy location identifier (e.g., a store identifier) included in a prescription product order and querying a datastore (e.g., one or more of the datastore(s) 110) to determine whether the pharmacy location identifier matches an identifier in a stored table, listing, or the like of contract pharmacy identifiers. If a match is detected, the prescription product order may be identified as having been received from a contract pharmacy that dispenses 340B drugs on behalf of a covered entity serviced by the service provider system 102.

The 340B eligibility determination module(s) 222 may include computer-executable instructions, code, or the like that, responsive to execution by one or more of the processor(s) 202, may cause processing to be performed to compare dispensing data received from one or more pharmacy computers 114 to patient encounter data received from one or more covered entity computers 118 associated with a covered entity to determine which dispenses were made on behalf of the covered entity to 340B eligible patients. As previously noted, this may be accomplished by comparing various data fields in data records of the dispensing data to corresponding data fields in data records of the patient encounter data to determine whether the data populated therein matches. The 340B eligibility determination module(s) 222 may also receive a data feed from one or more third-party service provider computers 116 that includes dispensing data for 340B qualifying dispenses made by contract pharmacies on behalf of one or more other covered entities serviced by one or more third-party service providers.

Based on testing dispensing data received from pharmacy computer(s) 114 in relation to patient encounter data, as well as, receipt of any 340B qualifying dispensing data from third-party service provider computer(s) 116, computer-executable instructions, code, or the like of the 340B eligibility determination module(s) 222 may be executed by one or more of the processor(s) 202 to determine the number of 340B accumulations accrued by a contract pharmacy on behalf of a covered entity over time and increment one or more counters based at least in part on the determined number of 340B accumulations.

The prescription product order partitioning module(s) 220 may include computer-executable instructions, code, or the like that, responsive to execution by one or more of the processor(s) 202, may cause processing to be performed to determine, based at least in part on the determined number of 340B accumulations, the number of ordered prescription drug items that can be replenished at the 340B price, and may partition the prescription drug orders accordingly.

Upon determination of the appropriate allocation of ordered prescription drug items between a covered entity's 340B account and a contract pharmacy's retail account, the prescription drug orders may be processed for fulfillment as described earlier. Computer-executable instructions, code, or the like of the 340B accumulation adjustment module(s) 226 may be executed by one or more of the processor(s) 202 to place a hold on 340B accumulations eligible for replenishment at the 340B price until confirmation is received that the order can be fulfilled. Upon receipt of confirmation, which may be in the form of, for example, an invoice, computer-executable instructions, code, or the like of the 340B accumulation adjustment module(s) 226 may be executed to decrement one or more counters of 340B accumulations by the number of 340B accumulations that resulted in replenishment of the drug at the 340B price.

In addition, computer-executable instructions, code, or the like of the reporting module(s) 228 may be executed by one or more of the processor(s) 202 to cause processing to be performed to provide any third-party service provider from whom dispensing data was received with various reports such as, for example, 340B accumulations reports, purchase reports, and so forth, as described above. Furthermore, computer-executable instructions, code, or the like of the invoicing/billing module(s) 230 may be executed by one or more of the processor(s) 202 to cause processing to be performed to generate invoices for billing contract pharmacies for revenues generated from the dispensing of drugs to 340B eligible patients on behalf of covered entities.

Referring now to other illustrative components stored in the data storage 212, the O/S 214 may be loaded from the data storage 212 into the memory 204 and may provide an interface between other application software executing on the device 200 and hardware resources of the device 200. More specifically, the O/S 214 may include a set of computer-executable instructions for managing hardware resources of the device 200 and for providing common services to other application programs (e.g., managing memory allocation among various application programs). The O/S 214 may include any operating system now known or which may be developed in the future including, but not limited to, any server operating system, any mainframe operating system, or any other proprietary or non-proprietary operating system.

The DBMS 216 may be loaded into the memory 204 and may support functionality for accessing, retrieving, storing, and/or manipulating data stored in the memory 204, data stored in the data storage 212, and/or data stored in the datastore(s) 110. The DBMS 216 may use any of a variety of database models (e.g., relational model, object model, etc.) and may support any of a variety of query languages. The DBMS 216 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like.

Referring now to other illustrative components of the device 200, one or more input/output (I/O) interfaces 206 may be provided that may facilitate the receipt of input information by the device 200 from one or more I/O devices as well as the output of information from the device 200 to the one or more I/O devices. The I/O devices may include, for example, one or more user interface devices that facilitate interaction between a user and the device 200 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The device 200 may further include one or more network interfaces 208 via which the device 200 may communicate with any of a variety of other systems, platforms, networks, devices, and so forth. Such communication may occur via any one or more of the network(s) 120.

It should be appreciated that the program modules, applications, computer-executable instructions, code, or the like depicted in FIG. 2 as being stored in the data storage 212 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the device 200, and/or hosted on other computing device(s) accessible via one or more networks, may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the device 200 may include alternate and/or additional hardware, software, or firmware components beyond those described or depicted without departing from the scope of the disclosure. More particularly, it should be appreciated that software, firmware, or hardware components depicted as forming part of the device 200 are merely illustrative and that some components may not be present or additional components may be provided in various embodiments. While various illustrative program modules have been depicted and described as software modules stored in data storage 212, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

### Illustrative Processes

FIGS. 3A-3B are process flow diagrams of an illustrative method 300 for determining whether a portion of an auto-generated prescription product order is eligible for replenishment at a reduced price in accordance with one or more example embodiments of the disclosure. One or more operations of the method 300 may be described herein as being performed by one or more devices of the service provider system 102 such as, for example, the prescription product order processing computer 104, the 340B eligibility determination computer 108, or the distribution center computer 112, or more specifically, by one or more program modules executing on such devices. It should be appreciated, however, that any operation of the method 300 described as being performed by a particular module executing on a particular device may be performed, at least in part, by another module executing on the same or a different device of the service provider system 102. Moreover, any operation of the method 300 may be performed by a device or component of the system architecture 100 other than a device of the service provider system 102 such as, for example, a pharmacy computer 114, third-party service provider computer 116, covered entity computer 118, or the like. In addition, it should be appreciated that processing performed in response to execution of computer-executable instructions provided as part of an application, program module, or the like may be interchangeably described herein as being performed by the application or the program module itself, by a device on which the application, program module, or the like is executing, or by a system that includes such a device. While the operations of the method 300 may be described in the context of the illustrative system architecture 100 and the illustrative device configuration depicted in FIG. 2, it should be appreciated the method 300 may be implemented in connection with numerous other architectural and device level configurations.

At block 302, the prescription product order processing computer 104 may receive prescription product orders, such as auto-generated electronic prescription product orders, from any number of pharmacy computers 114 provided locally or remotely from any number of corresponding pharmacy locations. In certain example embodiments, the prescription product order processing computer 104 may receive the electronic prescription product orders via one or more of the network(s) 120.

At block 304, upon receipt of such prescription product orders, computer-executable instructions of the contract pharmacy identification module(s) 218 may be executed to perform processing to identify those orders received from contract pharmacies that have contracted to dispense 340B drugs on behalf of covered entities serviced by a service provider that operates the service provider system 102. Such processing may include locating a pharmacy location identifier (e.g., a store identifier) included in a prescription product order and querying a datastore (e.g., one or more of the datastore(s) 110) to determine whether the pharmacy location identifier matches an identifier in a stored table, listing, or the like of contract pharmacy identifiers. If a match is detected, the prescription product order may be identified as having been received from a contract pharmacy. Upon identifying a subset of prescription product orders received from contract pharmacies, the prescription product order processing computer 104 may transmit the subset of orders (e.g., information included in the subset of orders) to the 340B eligibility determination computer 108 via the EDI 106. It should be appreciated that, in certain example embodiments, all prescription product orders received at block 302 may be received from or on behalf of contract pharmacies, in which case, the subset identified at block 304 may represent the entire set of received orders.

Upon receipt of one or more EDI messages that include data contained in the subset of prescription product orders identified at block 304, the 340B eligibility determination computer 108 may store the order data in one or more of the datastore(s) 110. At block 306, the 340B eligibility determination computer 108 may receive a first data feed from one or more pharmacy computers 114 that includes dispensing data for at least the contract pharmacies that submitted prescription product orders included in the subset of orders. In certain example embodiments, the dispensing data may include data for contract and non-contract pharmacies alike, and the dispensing data corresponding to contract pharmacies may be identified by matching pharmacy location identifiers included in the dispensing data to stored identifiers known to be associated with contract pharmacies. At block 308, the 340B eligibility determination computer 108 may further receive patient encounter data from a covered entity via one or more covered entity computers 118.

At block 310, computer-executable instructions of the 340B eligibility determination module(s) 222 may be executed to compare the dispensing data included in the first data feed to the received patient encounter data to identify 340B qualifying dispenses. More specifically, the dispensing data received from the pharmacy computer(s) 114 may include multiple data records with each data record corresponding to a particular dispensing of a drug. Each data record may indicate, for example, an NDC identifier for the drug, the number of dispensed units of the drug, a prescription identifier (e.g., a prescription number), a patient identifier indicating the patient to whom the drug was dispensed (e.g., an alphanumeric identifier such as a social security number or insurance payor member ID, other patient identifying information such as name, address, gender, age, etc., and so forth), a code, flag, or other identifier indicating whether the patient was an inpatient or an outpatient, and so forth. In certain example embodiments, in addition to or in lieu of an indication of the number of dispensed units of the drug, a data record may include dosage information and days supply information, and the number of dispensed units may be calculated from the dosage information and the days supply information. The patient encounter data may include a respective data record corresponding to each patient encounter with the covered entity. An example data record included in the patient encounter data may include a patient identifier, a covered entity identifier, a prescription identifier, an NDC code, and so forth. The covered entity identifier may include, for example, a national provider identifier (NPI), a Drug Enforcement Agency (DEA) number, or the like.

The 340B eligibility determination module(s) 222 may execute one or more scripts or the like to perform one or more comparisons of the dispensing data to the patient encounter data to determine those dispenses that were made on behalf of the covered entity to 340B eligible patients. As a non-limiting example, if a data record included in the patient encounter data includes a patient identifier and a prescription identifier that matches corresponding identifiers included in a data record of the dispensing data, the corresponding dispensing may be determined to be a 340B qualifying dispensing. Additional or alternative identifiers may need to match as well. For example, a same code or identifier indicating that the patient is an outpatient may need to be present in both the dispensing data record and the patient encounter data record, a same NDC identifier included in both the dispensing data record and the patient encounter data record may need to correspond to a prescription drug eligible for 340B pricing, and so forth.

In certain example embodiments, at block 312, the 340B eligibility determination computer 108 may receive a second data feed from one or more third-party service provider computers 116 that includes dispensing data for 340B qualifying dispenses made by the contract pharmacy on behalf of one or more other covered entities serviced by one or more third-party service providers.

Based on the comparison performed at block 310 and/or the second data feed received at block 312, the 340B eligibility determination module(s) 222 may determine the number of 340B accumulations accrued by a contract pharmacy on behalf of a covered entity over time (e.g., on a daily basis, weekly basis, monthly basis, etc.). As previously noted, it should be appreciated that the number of 340B accumulations may be evaluated on a per-contract pharmacy basis or may be consolidated across all contract pharmacies (or some subset thereof) that have contracted to dispense drugs to 340B eligible patients on behalf of a covered entity. In certain example embodiments, a respective counter may be maintained for each contract pharmacy that indicates the number of 340B accumulations that the contract pharmacy has accrued. In other example embodiments, a counter may be maintained that indicates 340B accumulations across multiple contract pharmacies for a particular covered entity. Further, in certain example embodiments, each counter that is maintained may correspond to a particular covered entity and any counters that are maintained may be stored in one or more of the datastore(s) 110.

At block 314, computer-executable instructions of the prescription product order partitioning module(s) 220 may be executed to determine whether the number of 340B accumulations accrued for a drug by a particular contract pharmacy (or a group of contract pharmacies) associated with a covered entity is at least as large as a minimum replenishment threshold for the drug. The minimum replenishment threshold may be the number of dispensable units of a drug that must be dispensed in order to replenish an incremental purchasable quantity of the drug. For example, if a drug is only sold in bottles that include 100 pills each, the incremental purchasable quantity is 100 pills (e.g., a complete bottle) and the minimum replenishment threshold is 100. The incremental purchasable quantity/minimum replenishment threshold of a drug may be determined from a stored table, listing, or the like that provides a set of NDC identifiers or RxNorm numbers and the corresponding incremental purchasable quantity/minimum replenishment threshold for each drug identified by the NDC identifier or RxNorm number.

If it is determined that the number of 340B accumulations is not at least as large as the minimum replenishment threshold, the method 300 may continue at block 316, where computer-executable instructions of the prescription product order partitioning module(s) 220 may be executed to allocate all of the prescription product items in the prescription order to a retail pharmacy account. The prescription product order information may then be transmitted to the distribution center computer 112 for fulfillment.

On the other hand, if it is determined that the number of 340B accumulations is at least as large as the minimum replenishment threshold, the method 300 may continue at block 320, wherein computer-executable instructions of the prescription product order partitioning module(s) 220 may be executed to determine the number of ordered prescription drug items that can be replenished at the 340B price. In particular, the number of increments of the incremental purchasable quantity of the drug may be determined from the number of 340B accumulations. For example, if a prescription drug is sold in 100-count bottles, the incremental purchasable quantity is 100 dispensable units of the drug (e.g., pills, capsules, etc.). Thus, if a contract pharmacy has ordered 10 items of the prescription drug, where each item is a 100-count bottle, and has accrued 220 340B accumulations, it may be determined at block 318 that 2 increments of the incremental purchasable quantity may be obtained at the 340B price, that is, 2 bottles that together include 200 dispensable units of the drug. The remaining 8 bottles of the order would then be purchased at the WAC price, for example.

Referring now to FIG. 3B, based on the determination at block 320, the prescription product order partitioning module(s) 220 may partition the prescription product order and may allocate, at block 322, the number of prescription drug items eligible for replenishment at the 340B price to a billing account that is maintained on behalf of the covered entity and for which the covered entity is responsible for payment, and may further allocate, at block 324, the remaining order prescription drug items to a retail billing account maintained on behalf of the contract pharmacy and for which the contract pharmacy is responsible for payment. Referring again to the example from above, the 2 bottles eligible for purchase at the 340B price may be billed to a 340B account maintained on behalf of the covered entity, and the remaining 8 bottles purchased at the WAC price may be billed to a retail account maintained on behalf of the contract pharmacy. It should be appreciated that, in various example embodiments, the 340B accumulations may be consolidated across multiple contract pharmacies in order to determine the number of increments of the incremental purchasable quantity of the drug that are eligible for replenishment at the 340B price.

The 340B eligibility determination computer 108 may then transmit the partitioned orders to the prescription product order processing computer 104 via the EDI 106. The prescription product order processing computer 104 may then perform any additional processing on the orders that is required and transmit, at block 326, the orders to the distribution center computer(s) 112 for fulfillment.

Upon receipt of the partitioned orders, the EDI 106 (or another device of the service provider system 102) may transmit an acknowledgment to the 340B eligibility determination computer 108. Upon receipt of the acknowledgment at block 328, computer-executable instructions of the 340B accumulation adjustment module(s) 224 may be executed at block 330 to place a hold on the 340B accumulations corresponding to those prescription product items replenished on the covered entity's 340B account at the 340B price. Once the prescription product orders are fulfilled, the 340B eligibility determination computer 108 may receive, at block 332, confirmation of prescription order fulfillment in the form, for example, of invoice information. At block 334, computer-executable instructions of the 340B accumulation adjustment module(s) 224 may be executed to decrement one or more counters by the number of 340B accumulations corresponding to the number of prescription drug items replenished at the 340B price. For example, assuming 505 340B accumulations for a contract pharmacy location and fulfillment of 5 100-count bottles at the 340B price, the 340B accumulations may be decremented from 505 340B accumulations to 5 340B accumulations.

In addition, at block 336, computer-executable instructions of the invoice modification module(s) 226 may be executed to modify the invoice information received at block 332 to replace any 340B pricing indicated in the invoice information with WAC pricing instead. For instance, in the example discussed above, the WAC price may instead be indicated for the 5 bottles purchased at the 340B price. At block 338, the modified invoice information may be transmitted to a pharmacy computer 114 associated with the contract pharmacy.

Furthermore, at block 340, computer-executable instructions of the reporting module(s) 228 may be executed to provide any third-party service provider from whom 340B eligible dispensing data was received with various reports such as, for example, a report identifying the number of 340B accumulations eligible for replenishment at the 340B price. The third-party service provider may utilize this information to decrement a counter that it maintains for the number of 340B accumulations for a covered entity. In addition, computer-executable instructions of the reporting module(s) 228 may be executed to provide a third-party service provider with a purchase report indicating purchase information for orders fulfilled for contract pharmacies dispensing 340B drugs on behalf a covered entity serviced by the third-party service provider. The purchase information may include, for example, an NDC identifier for the drug, the number of units purchased at the 340B price, the number of units purchased at the WAC price, an invoice identifier, and so forth.

FIG. 4 is a process flow diagram of an illustrative method 400 for invoicing contract pharmacies for revenues obtained by the contract pharmacies for 340B qualifying dispenses that have been replenished and which were made on behalf a covered entity in accordance with one or more example embodiments of the disclosure. One or more operations of the method 400 may be described herein as being performed by one or more devices of the service provider system 102 such as, for example, the 340B eligibility determination computer 108, or more specifically, by one or more program modules executing on the 340B eligibility determination computer 108 such as, for example, the invoicing/billing module(s) 230. It should be appreciated, however, that any operation of the method 400 described as being performed by a particular module executing on a particular device may be performed, at least in part, by another module executing on the same or a different device of the service provider system 102. Moreover, any operation of the method 400 may be performed by a device or component of the system architecture 100 other than a device of the service provider system 102 such as, for example, a pharmacy computer 114, third-party service provider computer 116, covered entity computer 118, or the like. In addition, it should be appreciated that processing performed in response to execution of computer-executable instructions provided as part of an application, program module, or the like may be interchangeably described herein as being performed by the application or the program module itself, by a device on which the application, program module, or the like is executing, or by a system that includes such a device. While the operations of the method 400 may be described in the context of the illustrative system architecture 100 and the illustrative device configuration depicted in FIG. 2, it should be appreciated the method 400 may be implemented in connection with numerous other architectural and device level configurations.

At block 402, the 340B eligibility determination computer 108 may receive first dispensing data from one or more pharmacy computers 114. In certain example embodiments, the first dispensing data received at block 402 may correspond to the dispensing data received in the first data feed at block 306 of method 300.

At block 404, the 340B eligibility determination computer 108 may receive patient encounter data from one or more covered entity computers 118. In certain example embodiments, the patient encounter data received at block 404 may correspond to the patient encounter data received at block 308 of method 300.

At block 406, the 340B eligibility determination computer 108 may receive, from one or more third-party service provider computers 116, second dispensing data identifying 340B qualifying dispenses. In certain example embodiments, the second dispensing data received at block 406 may correspond to the dispensing data received in the first data feed at block 312 of method 300.

At block 408, computer-executable instructions of the 340B eligibility determination module(s) 222 may be executed to determine the number of 340B eligible dispenses for each contract pharmacy based at least in part on the first dispensing data, the patient encounter data, and/or the second dispensing data. The number of 340 eligible dispenses may be determined on a per-covered entity basis. For example, if the covered entity is serviced by a service provider that operates or controls the service provider system 102, the first dispensing data may be compared to the patient encounter data in a manner similar to block 310 of method 300 to determine the number of 340B qualifying dispenses made by a contract pharmacy on behalf of the covered entity. If the covered entity is serviced by a third-party service provider, the number of 340B qualifying dispenses made by the contract pharmacy on behalf of the covered entity may be determined from the second dispensing data.

At block 410, computer-executable instructions of the invoicing/billing module(s) 230 may be executed to determine the amount of revenue received by the contract pharmacy from the 340B eligible dispenses. This information may have been received as part of the first dispensing data or may have been separately received. In certain example embodiments,

At block 412, computer-executable instructions of the invoicing/billing module(s) 230 may be executed to determine an amount that a contract pharmacy should be invoiced. The invoice amount may be determined by subtracting applicable dispensing fees from revenues received by the contract pharmacy for the 340B eligible dispenses. In certain example embodiments, the contract pharmacy may not be invoiced for 340B qualifying dispenses until the drug has been replenished at the 340B price. For example, if 30 tablets dispensed from a 100-count bottle are determined to be 340B eligible, the contract pharmacy may not be invoiced for the corresponding revenues (less dispensing fees) until an additional 70 tablets are dispensed to 340B eligible patients and the 100-count bottle is replenished at the 340B price. In other example embodiments, the contract pharmacy may be invoiced for a percentage of the 340B eligible dispenses that have been replenished. For example, if the contract pharmacy dispensed, within the same invoicing cycle, 50 tablets to a first 340B eligible patient and 60 tablets to a second 340B eligible patient, and replenished its inventory with a 100-count bottle at the 340B price, then the contract pharmacy may be invoiced for the full amount of revenue (less dispensing fees) received for the 50 tablet dispensing and may be invoiced for only ⅙ of the revenue (less dispensing fees) received for the 60 tablet dispensing.

At block 414, computer-executable instructions of the invoicing/billing module(s) 230 may be executed to transmit invoice information to a pharmacy computer 114 operating on behalf of the contract pharmacy. At block 416, the service provider system 102 may receive payment from the contract pharmacy and may store the funds in a funds repository. At block 418, the service provider system 102 may remit the funds to a financial account maintained on behalf of the appropriate covered entity. If the covered entity is serviced by a third-party service provider, the service provider system 102 may, at block 420, remit the funds to a financial account maintained by or on behalf of the third-party service provider for eventual distribution to the appropriate covered entity.

The operations described and depicted in the illustrative methods of FIGS. 3A-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 3A-4 may be performed.

While certain example embodiments disclosed herein have been described as involving the transmission or receipt of data between the service provider system 102 (or devices forming part thereof) and other illustrative components of the illustrative architecture 100, in certain other example embodiments, such transmissions may be internal transmissions occurring within the service provider system 102 or may be omitted altogether. Further, while example embodiments described herein with reference to FIGS. 1-4 describe certain example operations as occurring at or being performed by one or more devices of the service provider system 102 or certain example data transmissions as originating at or being received by one or more devices of the service provider system 102, in alternative example embodiments, such example data transmissions may originate at or may be received by, or such example operations may occur at or may be performed by, the pharmacy computer 114, the third-party service provider computer 116, the covered entity computer 118, another separate and distinct computer or computer system, a combination of two or more such devices, and/or a combination of one or more such devices along with one or more devices of the service provider system 102. In such alternate example embodiments, certain transmission/receiving steps and/or certain data transmissions described above with reference to FIGS. 1-4 may be omitted while others may be added, as will be understood by one of ordinary skill in the art. The intent being that, in alternate example embodiments, any of the devices/computers described and depicted with respect to FIG. 1 are capable of performing any one or more operations or originating/receiving any one or more data transmissions of any of the methods described with reference to FIGS. 1-4.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program modules, applications, or the like disclosed herein may include one or more software components including, for example, software objects, methods, data structures, or the like. Each such software component may include computer-executable instructions that, responsive to execution, may cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A computer-implemented method, comprising:
receiving, by a service provider system comprising one or more computers from a pharmacy system, a prescription drug order comprising an order for a plurality of stock keeping units (SKUs) of the prescription drug and a pharmacy identifier;
determining, by the service provider system, that the pharmacy identifier included in the prescription drug order matches a stored identifier of a contract pharmacy;
receiving, by the service provider system from the pharmacy system, a data feed that comprises dispensing data for the contract pharmacy, wherein the dispensing data comprises a plurality of dispensing data records, each dispensing data record corresponding to a particular dispensing of the prescription drug to a particular patient;
receiving, by the service provider system, patient encounter data comprising a description of patient encounters with a covered entity, wherein the patient encounter data comprises a plurality of patient encounter data records, each patient encounter data record corresponding to a particular patient encounter with the covered entity;
identifying, by the service provider system, a subset of the plurality of dispensing data records, wherein each dispensing data record in the subset comprises one or more identifiers that match one or more identifiers in a corresponding patient encounter data record, and wherein each dispensing data record in the subset corresponds to dispensing to a respective 340B eligible patient of the covered entity;
determining, by the service provider system, a number of units of the prescription drug dispensed by the contract pharmacy to 340B eligible patients on behalf of the covered entity from data included in the subset of the plurality of dispensing data records;
incrementing, by the service provider system, a counter of 340B accumulations by the number of units of the prescription drug dispensed by the contract pharmacy to 340B eligible patients;
determining, by the service provider system, a number of the plurality of SKUs purchasable at a 340B price of the prescription drug based on a comparison of the counter of 340B accumulations to a minimum 340B replenishment threshold;
partitioning, by the service provider system, the prescription drug order to generate a first order for the number of the plurality of SKUs purchasable at the 340B price and a second order for a remainder of the plurality of SKUs; and
allocating, by the service provider system, the first order to a first account maintained on behalf of the covered entity and the second order to a second account maintained on behalf of the contract pharmacy.

2. The computer-implemented method of claim 1, further comprising:
transmitting, by the service provider system, the first order and the second order for fulfillment;
receiving, by the service provider system, an acknowledgment of receipt of at least the first order; and
placing, by the service provider system and responsive to receiving the acknowledgment, a hold on a portion of the 340B accumulations corresponding to the number of SKUs of the prescription drug included in the first order.

3. The computer-implemented method of claim 2, further comprising:
receiving, by the service provider system, a confirmation message indicating that at least the first order has been fulfilled;
decrementing, by the service provider system, the counter of 340B accumulations by the number of SKUs of the prescription drug included in the first order.

4. The computer-implemented method of claim 1, further comprising:
modifying, by the service provider system, an invoice for the prescription drug order to generate a modified invoice that reflects a wholesale acquisition cost price for each item included in the first order; and
transmitting, by the service provider system, the modified invoice to the pharmacy computer.

5. A computer-implemented method, comprising:
receiving, by a service provider system comprising one or more computers from a pharmacy system, a prescription product order for one or more stock keeping units (SKUs) of a prescription product;
determining, by the service provider system, that the prescription product order is received on behalf of a contract pharmacy that has contracted to dispense the prescription product on behalf of a covered entity;
receiving, by the service provider system from the pharmacy system, a data feed that comprises dispensing data for the contract pharmacy;
receiving, by the service provider system, patient encounter data describing patient encounters between the covered entity and 340B eligible patients of the covered entity;
determining, by the service provider system and based at least in part on a comparison of the dispensing data and the patient encounter data, a number of units of the prescription product dispensed by the contract pharmacy to the 340B eligible patients of the covered entity;
incrementing, by the service provider system, a number of 340B accumulations by the number of units of the prescription product dispensed by the contract pharmacy to the 340B eligible patients;
determining, by the service provider system, that the number of 340B accumulations meets or exceeds a minimum incremental amount of the prescription product purchasable at a 340B price for the prescription product;
determining, by the service provider system, a number of the one or more SKUs of the prescription product eligible for purchase at the 340B price based at least in part on the number of 340B accumulations; and
allocating, by the service provider system, the number of the one or more SKUs of the prescription product eligible for purchase at the 340B price to an account maintained on behalf of the covered entity that is distinct from a retail account maintained on behalf of the contract pharmacy.

6. The computer-implemented method of claim 5, wherein determining the number of the one or more SKUs of the prescription product eligible for purchase at the 340B price comprises determining a number of increments of the minimum incremental amount of the prescription product included in the number of 340B accumulations.

7. The computer-implemented method of claim 5, wherein the prescription product order is a first prescription product order, the method further comprising:
generating, by the service provider system, a second prescription product order for the number of the one or more SKUs of the prescription product eligible for purchase at the 340B price.

8. The computer-implemented method of claim 7, further comprising:
transmitting, by the service provider system, the second prescription product order for fulfillment;
receiving, by the service provider system, an acknowledgment of receipt of the second prescription product order; and
placing, by the service provider system and responsive to receiving the acknowledgment, a hold on a portion of the 340B accumulations corresponding to the number of dispensable units of the prescription product included in the number of the one or more SKUs of the prescription product.

9. The computer-implemented method of claim 8, further comprising:
receiving, by the service provider system, a confirmation message indicating that the second prescription product order has been fulfilled; and
decrementing, by the service provider system, the counter of 340B accumulations by the number of the dispensable units of the prescription product included in the number of the one or more SKUs of the prescription product.

10. The computer-implemented method of claim 5, wherein the prescription product order is a first prescription product order, the contract pharmacy is a first contract pharmacy, and the dispensing data is first dispensing data, the method further comprising:
receiving, by the service provider system, a second prescription product order for the prescription product, wherein the second prescription product order includes an identifier of a second contract pharmacy that has contracted to dispense the prescription product on behalf of the covered entity;
receiving, by the service provider system, second dispensing data for the second contract pharmacy;
determining, by the service provider system and based at least in part on a comparison of second dispensing data and the patient encounter data, a number of units of the prescription product dispensed by the second contract pharmacy to 340B eligible patients of the covered entity;
incrementing, by the service provider system, the number of 340B accumulations by the number of units of the prescription product dispensed by the second contract pharmacy to 340B eligible patients;
determining, by the service provider system, a total number of SKUs of the prescription product eligible for purchase at the 340B price based at least in part on the number of 340B accumulations; and
allocating, by the service provider system, the total number of SKUs of the prescription product eligible for purchase at the 340B price to the account maintained on behalf of the covered entity.

11. The computer-implemented method of claim 5, wherein the one or more SKUs comprises a plurality of SKUs, the data feed is a first data feed, and the covered entity is a first covered entity, the method further comprising:
receiving, by the service provider system from a third-party service provider system, a second data feed comprising an indication of a number of units of the prescription product dispensed by the contract pharmacy to 340B eligible patients of a second covered entity that is not serviced by the service provider system;
incrementing, by the service provider system, a number of 340B accumulations accrued by the contract pharmacy on behalf of the second covered entity by the number of units of the prescription product dispensed by the contract pharmacy to 340B eligible patients of the second covered entity;
determining, by the service provider system, an additional number of the plurality of items of the prescription product eligible for purchase at a 340B price based at least in part on the number of 340B accumulations accrued by the contract pharmacy on behalf of the second covered entity; and
allocating, by the service provider system, the additional number of the plurality of SKUs of the prescription product eligible for purchase at the 340B price to an account maintained on behalf of the second covered entity.

12. The method of claim 5, further comprising:
determining, by the service provider system, an amount of revenue received by the contract pharmacy for a portion of the number of units of the prescription product dispensed by the contract pharmacy that have been replenished at the 340B price;
determining, by the service provider system, an amount of dispensing fees charged by the contract pharmacy for the portion of the number of units of the prescription product dispensed by the contract pharmacy; and
determining, by the service provider system, an invoice amount for the portion of the number of units of the prescription product dispensed by the contract pharmacy by subtracting the amount of dispensing fees from the amount of revenue.

13. A system, comprising;
at least one memory storing computer-executable instructions; and
at least one processor configured to access the at least one memory and to execute the computer-executable instructions to:
receive, from a pharmacy system, a prescription product order for one or more stock keeping units (SKUs) of a prescription product;
determine that the prescription product order is received on behalf of a contract pharmacy that has contracted to dispense the prescription product on behalf of a covered entity;
receive, from the pharmacy system, a data feed that comprises dispensing data for the contract pharmacy;
receive patient encounter data describing patient encounters between the covered entity and 340B eligible patients of the covered entity;
determine, based at least in part on a comparison of the dispensing data and the patient encounter data, a number of units of the prescription product dispensed by the contract pharmacy to the 340B eligible patients of the covered entity;
increment a number of 340B accumulations by the number of units of the prescription product dispensed by the contract pharmacy to the 340B eligible patients;
determine that the number of 340B accumulations meets or exceeds a minimum incremental amount of the prescription product purchasable at a 340B price for the prescription product;
determine a number of the one or more SKUs of the prescription product eligible for purchase at the 340B price based at least in part on the number of 340B accumulations; and
allocate the number of the one or more SKUs of the prescription product eligible for purchase at the 340B price to an account maintained on behalf of the covered entity.

14. The system of claim 13, wherein the at least one processor is configured to determine the number of the one or more SKUs of the prescription product eligible for purchase at the 340B by executing the computer-executing instructions to determine a number of increments of the minimum incremental amount of the prescription product included in the number of 340B accumulations.

15. The system of claim 13, wherein the prescription product order is a first prescription product order, and the at least one processor is further configured to execute the computer-executable instructions to:
generate a second prescription product order for the number of the one or more SKUs of the prescription product eligible for purchase at the 340B price.

16. The system of claim 15, wherein the at least one processor is further configured to execute the computer-executable instructions to:
transmit the second prescription product order for fulfillment;
receive an acknowledgment of receipt of the second prescription product order; and
place, responsive to receiving the acknowledgment, a hold on a portion of the 340B accumulations corresponding to a number of dispensable units of the prescription product included in the number of the one or more SKUs of the prescription product.

17. The system of claim 16, wherein the at least one processor is further configured to execute the computer-executable instructions to:
receive a confirmation message indicating that the second prescription product order has been fulfilled; and
decrement the counter of 340B accumulations by the number of dispensable units of the prescription product included in the number of the one or more SKUs of the prescription product.

18. The system of claim 13, wherein the prescription product order is a first prescription product order, the contract pharmacy is a first contract pharmacy, and the dispensing data is first dispensing data, and wherein the at least one processor is further configured to execute the computer-executable instructions to:
receive a second prescription product order for the prescription product, wherein the second prescription product order is associated with a second contract pharmacy that has contracted to dispense the prescription product on behalf of the covered entity;
receive second dispensing data for the second contract pharmacy;
determine, based at least in part on a comparison of second dispensing data and the patient encounter data, a number of units of the prescription product dispensed by the second contract pharmacy to 340B eligible patients of the covered entity;
increment the number of 340B accumulations by the number of units of the prescription product dispensed by the second contract pharmacy to the 340B eligible patients; and
determine a total number of SKUs of the prescription product eligible for purchase at the 340B price based at least in part on the number of 340B accumulations; and
allocate the total number of SKUs of the prescription product eligible for purchase at the 340B price to the account maintained on behalf of the covered entity.

19. The system of claim 13, wherein the one or more SKUs comprises a plurality of SKUs, the data feed is a first data feed, and the covered entity is a first covered entity, and wherein the at least one processor is further configured to execute the computer-executable instructions to:
receive, from a third-party service provider system, a second data feed comprising an indication of a number of units of the prescription product dispensed by the contract pharmacy to 340B eligible patients of a second covered entity that is not serviced by the service provider system;
increment a number of 340B accumulations accrued by the contract pharmacy on behalf of the second covered entity by the number of units of the prescription product dispensed by the contract pharmacy to the 340B eligible patients of the second covered entity;
determine an additional number of the plurality of SKUs of the prescription product eligible for purchase at a 340B price based at least in part on the number of 340B accumulations accrued by the contract pharmacy on behalf of the second covered entity; and
allocate the additional number of the plurality of SKUs of the prescription product eligible for purchase at the 340B price to an account maintained on behalf of the second covered entity.

20. The system of claim 13, wherein the at least one processor is further configured to execute the computer-executable instructions to:
determine an amount of revenue received by the contract pharmacy for a portion of the number of units of the prescription product dispensed by the contract pharmacy that have been replenished at the 340B price;
determine an amount of dispensing fees charged by the contract pharmacy for the portion of the number of units of the prescription product dispensed by the contract pharmacy; and
determine an invoice amount for the portion of the number of units of the prescription product dispensed by the contract pharmacy by subtracting the amount of dispensing fees from the amount of revenue.
